(19) United States
(12) Patent Application Publication
(10) Pub. No.: US 2009/0111382 A1
(43) Pub. Date: Apr. 30, 2009

(54) METHODS FOR SCHEDULING COLLECTION OF KEY PERFORMANCE INDICATORS FROM ELEMENTS IN A COMMUNICATIONS NETWORK

(75) Inventor: Yi-Zhi Yao, Beijing (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/252,575

(22) Filed: Oct. 16, 2008

(30) Foreign Application Priority Data
Oct. 26, 2007 (CN) 2007101067804.0

(51) Int. Cl. H04B 10/08

(52) U.S. Cl. 455/67.7

(57) ABSTRACT

A method for scheduling collection of key performance indicators from elements in a communications network as provided improves network efficiency by reducing redundant KPI data transmission. The method includes defining a first key performance indicator request set by matching a first request for a key performance indicator with a second request for a key performance indicator (step 405). A maximum collection frequency for the first key performance indicator request set is then determined (step 410). Next, collection of key performance indicators defined in the first key performance indicator request set is scheduled at a rate equal to or greater than the maximum collection frequency (step 415).

### FIELD OF THE INVENTION

The present invention relates generally to communication services in wireless networks, and in particular to scheduling efficient collection of key performance indicators from network elements.

### BACKGROUND

Wireless communication networks, such as second generation and third generation (2G/3G) mobile networks, employ telecommunications management network (TMN) principles to obtain interconnectivity and network efficiency across heterogeneous network components. TMN is a protocol defined by the telecommunication standardization sector of the international telecommunications union (ITU-T) and is based on the open systems interconnection (OSI) network model.

TMN defines four logical layers of network management: A business management layer is a top layer that performs business analysis functions such as analyzing subscriber trends and quality issues for the purposes of billing and financial reports. Next, a service management layer concerns administration and charging services. Next, a network management layer concerns configuration, control and supervision of network resources. Finally, an element management layer concerns alarm management, information processing, backup, logging, and maintenance of hardware and software resources of individual network elements.

Key performance indicators (KPIs) are used by TMN logical layers to provide network operators with well-understood parameters concerning the effectiveness of network services that are provided to end users. KPIs can measure various parameters associated with, for example, network accessibility, call retainability, device mobility, and network capacity. KPIs thus can be used to detect potential network resource problems and to isolate and verify mitigation of resource problems.

### BRIEF DESCRIPTION OF THE FIGURES

In order that the invention may be readily understood and put into practical effect, reference will now be made to exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a network diagram illustrating a hierarchy of network management entities operating in a communications network, according to some embodiments of the present invention;

FIG. 2 is a message sequence diagram illustrating key performance indicator (KPI) communications between a network management system (NMS), and two element management systems (EMSs), according to some embodiments of the present invention;

FIG. 3 is a message sequence and general flow diagram illustrating processing of KPI request messages, according to some embodiments of the present invention;

FIG. 4 is a general flow diagram illustrating a method for scheduling collection of key performance indicators from elements in a communications network, according to some embodiments of the present invention; and

FIG. 5 is a block diagram illustrating system components of an element management system (EMS), according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and device components related to scheduling collection of key performance indicators from elements in a communications network. Accordingly, the device components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, front and back, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device. An element preceded by “comprises a . . . ” does not, without more constraints, preclude the existence of additional identical elements in the process, method, article, or apparatus that comprises the element.

According to one aspect, the present invention comprises a method for scheduling collection of key performance indicators from elements in a communications network. The method includes defining a first key performance indicator request set by matching a first request for a key performance indicator with a second request for a key performance indicator. A maximum collection frequency for the first key performance indicator request set is then determined. Next, collection of key performance indicators defined in the first key performance indicator request set is scheduled at a rate equal to or greater than the maximum collection frequency.

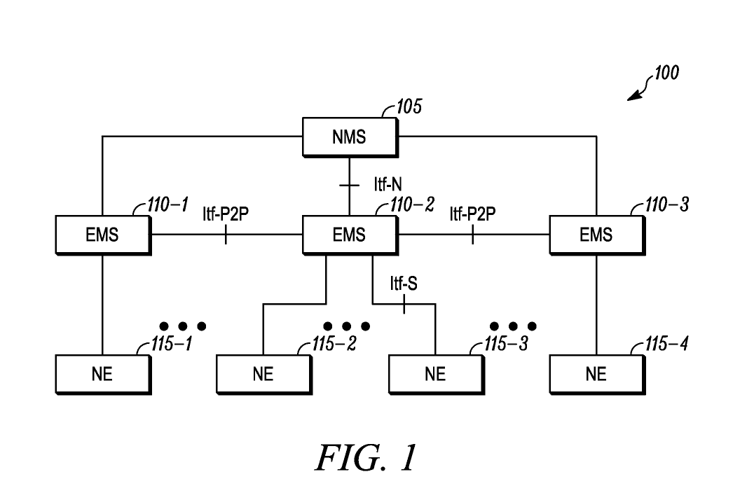

Referring to FIG. 1, a network diagram illustrates a hierarchy of network management entities operating in a communications network 100, according to some embodiments of the present invention. A network management system (NMS) 105 oversees all network management operations and is in direct communication with a plurality of element management systems (EMS) 110-n (i.e., 110-1, 110-2, and 110-3). The EMSs 110-n are also in communication with each other using peer-to-peer interfaces (Itf-P2P). Finally, network elements (NEs) 115-n (i.e., 115-1, 115-2, 115-3, and 115-4) are each in direct communication with one EMS 110-n.

The communications network 100 is thus a multi-manager environment, because a single management entity in the network 100, such as the EMS 110-2, can be required to collect and calculate key performance indicator (KPI) data for multiple other entities in the network 100. For example, the EMS 110-2 may be required to provide KPIs to the NMS 105 over an “N” interface (Itf-N), and also provide KPIs to both the EMS 110-1 and the EMS 110-3 over the Itf-P2Ps. Further, because the NMS 105 and the EMSs 110-n can each initiate and define specific and independent KPI collection processes, there is a high probability that some of the KPIs requested from one entity will overlap with some of the KPIs requested from another entity. An overlapped KPI is thus a KPI that is requested by multiple network entities concerning an identical parameter measured during an overlapping time period. According to the teachings of the present invention, the efficient management of overlapped KPIs can thus enable improved network operating efficiency, as less redundant KPI data need to be routed between network entities.

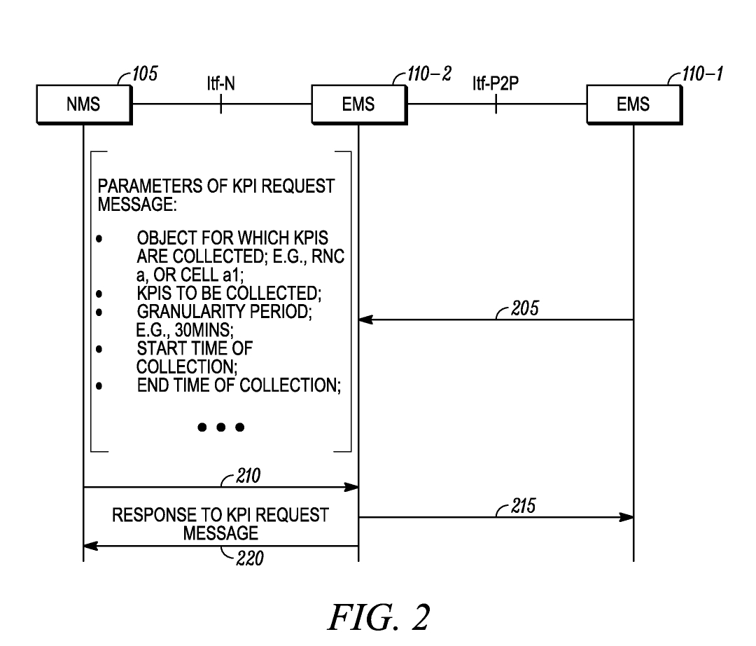

Referring to FIG. 2, a message sequence diagram illustrates KPI communications between the NMS 105, the EMS 110-1 and the EMS 110-2, according to some embodiments of the present invention. (For simplicity, KPI communications between the EMS 110-3 and the EMS 110-2 are not shown.) The EMS 110-2 first receives a KPI request message 205 from the EMS 110-1. Next, the EMS 110-2 receives a KPI request message 210 from the NMS 105. Both of the KPI request messages 205, 210 include various parameters. For example, as shown, the parameters may include an object for which the KPIs are being collected. For example, an object may be to collect performance data for a specific radio network controller (RNC) or for a particular network cell. Other parameters include identifying the KPIs to be collected, a granularity period during which the KPIs should be measured, a start time of collection for the KPIs, and an end time of collection for the KPIs. A similar KPI request message also may be received from the EMS 110-3.

After the KPI request messages 205, 210 are received at the EMS 110-2, they are collectively processed according to the teachings of the present invention, which are described in detail below. After such processing, the EMS 110-2 transmits KPI response messages 215, 220 to the EMS 110-1 and the NMS 105, respectively. The KPI response messages 215, 220 inform the EMS 110-1 and the NMS 105 concerning whether a request for collection of particular KPI data can be satisfied by the EMS 110-2.

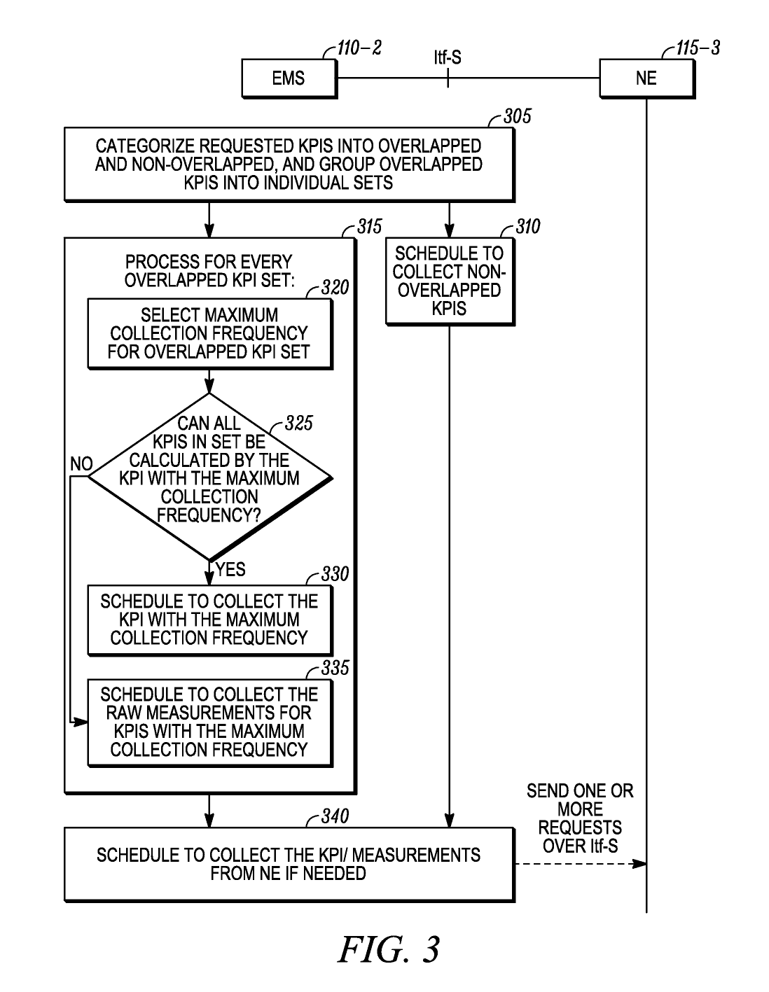

Referring to FIG. 3, a message sequence and general flow diagram illustrates processing of KPI request messages, such as the KPI request messages 205 and 210, at the EMS 110-2, according to some embodiments of the present invention. At step 305, KPI data requested in the KPI request messages 205, 210 are categorized into overlapped and non-overlapped KPIs. Further, overlapped KPIs are grouped into overlapped KPI sets. As described above, an overlapped KPI is a KPI that is requested by multiple network entities concerning an identical parameter measured during an overlapping time period. For example, consider that the KPI request message 205 requests a call success rate KPI beginning at 12:00 on September 1, reported every 30 minutes until 18:00 on September 1; and the KPI request message 210 requests a call success rate KPI beginning at 12:00 on September 1, reported every 15 minutes until 18:00 on September 1. The requested call success rate KPIs would overlap because they are for identical parameters (e.g., “number of successful calls”/“number of attempted calls”) and for overlapping time periods.

At step 310, collection of any non-overlapped KPIs among the requested KPIs is scheduled. For example, if only the EMS 110-1 requested a KPI concerning a call drop rate, and neither the NMS 105 nor the EMS 110-3 requested a call drop rate KPI, then that KPI would be considered a non-overlapped KPI. Similarly, if both the EMS 110-1 and the NMS 105 requested a KPI concerning a call drop rate, but for different and non-overlapping time periods, then that KPI also would be considered a non-overlapped KPI.

At block 315, each overlapped KPI set is then processed. That includes, at step 320, selecting a maximum collection frequency for an overlapped KPI set. For example, where the KPI request message 205 requests a call success rate KPI every 30 minutes, and the KPI request message 210 requests a call success rate KPI every 15 minutes, then a maximum collection frequency for the resulting call success rate overlapped KPI set would be once every 15 minutes.

At step 325 it is determined whether all KPIs in an overlapped KPI set can be calculated by the KPI with the maximum collection frequency. For example, considering again the call success rate KPIs described above, although the call success rate KPI requested by the EMS 110-1 every 30 minutes overlaps with the call success rate KPI requested by the NMS 105 every 15 minutes, the KPI requested by the EMS 110-1 cannot be determined by the by the KPI requested by the NMS 105. That is because the call success rate every 30 minutes cannot be simply determined by the following Equation 1:

(“KPI of 1^{st} 15 min.”+“KPI of 2^{nd} 15 min.”)/2=KPI of 30 min. (Eq. 1)

Equation 1 would work if an attempted call frequency was constant. But in an actual network, the attempted call frequency during the first 15 minutes of the 30 minute period could be, for example, double the attempted call frequency during the second 15 minutes of the 30 minute period. Thus a simple averaging of 15 minute periods according to Equation 1 can introduce significant errors. Therefore, the call success rate every 30 minutes should be determined according to the following Equation 2:

“No. successful calls in 30 min.”/“No. attempted calls in 30 min”=KPI of 30 min. (Eq. 2)

At step 330, if all KPIs in an overlapped KPI set can be calculated by the KPI with the maximum collection frequency, then collection of the KPI at the maximum collection frequency is scheduled. However, if not, then at step 335 collection of raw measurements for the KPIs is scheduled at the maximum collection frequency. Raw measurements, also called original measurement data, for a KPI comprise the preliminary data used to calculate the KPI. For example, the original measurement data for the call success rate KPI described above include the variables “number of successful calls” and “number of attempted calls”.

Finally, at step 340, collection of all necessary KPIs and/or raw measurement data are scheduled with relevant network elements. For example, the EMS 110-2 may schedule collection of the raw measurements described above for a call success rate KPI with the NE 115-3. Requests for the collection of the scheduled data are then sent to particular network elements. For example, the EMS 110-2 transmits a collection request to the NE 115-3 over the Itf-S interface.

According to various embodiments of the present invention, key performance indicators can measure network performance in various categories, including in at least one of the following categories: network accessibility, call retainability, device mobility, and network capacity. Further, the key performance indicators can be selected from the following group: radio access bearer establishment success rate, authentication successful rate, radio resource control connection establishment success rate, call setup success rate, connection drop rate, call drop rate, packet drop rate, outgoing hard handover success rate, outgoing inter-system handover success rate, soft handover success rate, call completion rate, network management system availability rates, and throughput measurements. KPIs can thus comprise various types of values, including, for example, a ratio value, a mean value, a maximum/minimum value, or a cumulative value associated with a network's performance.

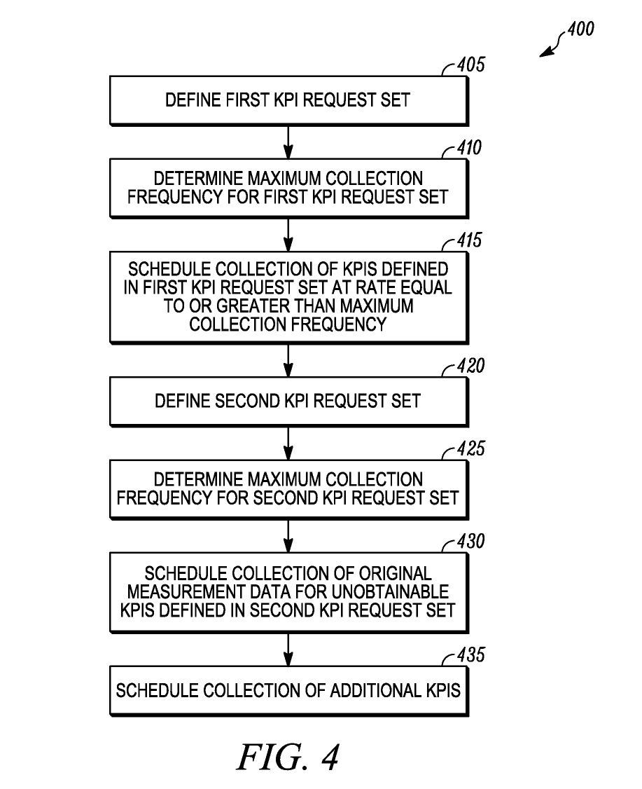

Referring to FIG. 4, a general flow diagram illustrates a method 400 for scheduling collection of key performance indicators from elements in a communications network, according to some embodiments of the present invention. At step 405, a first key performance indicator request set is defined by matching a first request for a key performance indicator with a second request for a key performance indicator. Matching the first request for a key performance indicator with the second request for a key performance indicator can comprise matching key performance indicator parameters. For example, at the EMS 110-2 a first request for a KPI, such as a radio resource control connection establishment success rate, defined in the KPI request message 205 received from the EMS 110-1 is matched with a second request for an associated KPI defined in the KPI request message 210 received from the NMS 105. The key performance indicator parameters can be selected, for example, from the following group: key performance indicator names, key performance indicator identifiers, and key performance indicator measured objects.

At step 410, a maximum collection frequency for the first key performance indicator request set is determined. The maximum collection frequency can be the greater of a defined collection frequency for the first request and a defined collection frequency for the second request. For example, where the KPI request message 205 requests a radio resource control connection establishment success rate KPI every 2 hours, and the KPI request message 210 requests a radio resource control connection establishment success rate KPI every 1 hour, then a maximum collection frequency for the resulting call success rate overlapped KPI set would be once every hour.

At step 415, collection of key performance indicators defined in the first key performance indicator request set is scheduled at a rate equal to or greater than the maximum collection frequency. For example, collection of a radio resource control connection establishment success rate KPI requested in the KPI request message 210 can be scheduled at a rate equal to or greater than once every hour.

At step 420, a second key performance indicator request set is defined. For example, the KPI request messages 205, 210 may also request call success rate KPIs during overlapping time periods.

At step 425, a maximum collection frequency for the second key performance indicator request set is determined. For example, where the KPI request message 205 requests a call success rate KPI every 30 minutes, and the KPI request message 210 requests a call success rate KPI every 15 minutes, then a maximum collection frequency for the resulting call success rate KPI set would be once every 15 minutes.

At step 430, collection of original measurement data for unobtainable key performance indicators defined in the second key performance indicator request set are scheduled, where the unobtainable key performance indicators cannot be calculated using only key performance indicators collected at a rate equal to or greater than the maximum collection frequency for the second key performance indicator request set. For example, the EMS 110-2 may schedule collection from the NE 115-3 of original measurement data including “number of successful calls” and “number of attempted calls” for a call success rate KPI, rather than scheduling collection of a simple average of call success rate KPIs.

At step 435, collection of additional key performance indicators that are not defined in the first key performance indicator request set is scheduled. For example, collection is scheduled for KPIs defined in a second KPI request set, and for non-overlapped KPIs.

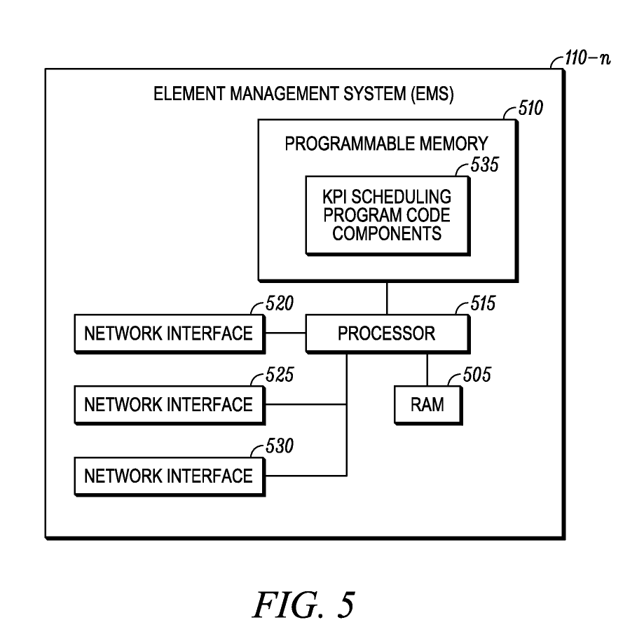

Referring to FIG. 5, a block diagram illustrates system components of an element management system (EMS) 110-n, according to some embodiments of the present invention. The EMS 110-n comprises a random access memory (RAM) 505 and a programmable memory 510 that are coupled to a processor 515.

The processor 515 also has ports for coupling to network interfaces 520, 525, 530, which may be wired or wireless network interfaces. The network interfaces 520, 525, 530 can be used to enable the EMS 110-n to communicate with elements in the network 100, such as the NMS 105, other EMSs 110-n, and the NEs 115-n. For example, the network interface 520 can process communications across the “S” interface (Ift-S) between the EMS 110-2 and the NE 115-3.

The programmable memory 510 can store operating code (OC) for the processor 515 and code for performing functions associated with an EMS. For example, the programmable memory 510 can comprise computer readable program code components 535 configured to cause execution of a method for scheduling collection of key performance indicators from elements in a communications network, as described herein.

Advantages of some embodiments of the present invention thus include improved network efficiency, as less redundant key performance indicator (KPI) data are transmitted in the network. Determinations of whether KPI data can be consolidated are made intelligently based on analysis of KPI parameters included in KPI request messages received from different network management entities. Thus a given network bandwidth overhead dedicated to transmission of management data including KPIs can provide more information to more network management entities, enabling better network performance and improved quality of service (QoS) to end users.

It will be appreciated that embodiments of the invention described herein may be comprised of one or more conventional processors and unique stored program instructions that control the one or more processors to implement, in conjunction with certain non-processor circuits, some, most, or all of the functions of scheduling collection of key performance indicators from elements in a communications network as described herein. The non-processor circuits may include, but are not limited to, a radio receiver, a radio transmitter, signal drivers, clock circuits, power source circuits, and user input devices. As such, these functions may be interpreted as steps of a method for scheduling collection of key performance indicators from elements in a communications network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims.

We claim:

1. A method for scheduling collection of key performance indicators from elements in a communications network, the method comprising:
defining a first key performance indicator request set by matching a first request for a key performance indicator with a second request for a key performance indicator;
determining a maximum collection frequency for the first key performance indicator request set; and
scheduling collection of key performance indicators defined in the first key performance indicator request set at a rate equal to or greater than the maximum collection frequency.

2. The method of claim 1, further comprising:
defining a second key performance indicator request set;
determining a maximum collection frequency for the second key performance indicator request set; and
scheduling collection of original measurement data for unobtainable key performance indicators defined in the second key performance indicator request set, where the unobtainable key performance indicators cannot be calculated using only key performance indicators collected at a rate equal to or greater than the maximum collection frequency for the second key performance indicator request set.

3. The method of claim 1, wherein the maximum collection frequency is the greater of a defined collection frequency for the first request and a defined collection frequency for the second request.

4. The method of claim 1, wherein matching the first request for a key performance indicator with the second request for a key performance indicator comprises matching key performance indicator parameters.

5. The method of claim 4, wherein the key performance indicator parameters are selected from the following group: key performance indicator names, key performance indicator identifiers, and key performance indicator measured objects.

6. The method of claim 1, further comprising scheduling collection of additional key performance indicators that are not defined in the first key performance indicator request set.

7. The method of claim 1, wherein the key performance indicators measure network performance in at least one of the following categories: network accessibility, call retainability, device mobility, and network capacity.

8. The method of claim 1, wherein the key performance indicators are selected from the following group: radio access bearer establishment success rate, authentication successful rate, radio resource control connection establishment success rate, call setup success rate, connection drop rate, call drop rate, packet drop rate, outgoing hard handover success rate, outgoing inter-system handover success rate, soft handover success rate, call completion rate, network management system availability rates, and throughput measurements.

9. The method of claim 1, wherein the key performance indicators comprise at least one of the following: a ratio value, a mean value, a maximum/minimum value and a cumulative value.

10. The method of claim 1, wherein the elements in the communications network are selected from the following group: network management systems, element management systems, and network elements.
